(19) United States
(12) Patent Application Publication
(10) Pub. No.: US 2008/0311897 A1
(43) Pub. Date: Dec. 18, 2008

(54) NETWORK CONTEXT BASED POLICY MANAGEMENT

(75) Inventor: Niranjan N. Segal, Arlington, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/764,427

(22) Filed: Jun. 18, 2007

(51) Int. Cl. H04M 3/42; H04M 7/00

(52) U.S. Cl. 455/418

(57) ABSTRACT

A method (200) of providing communication services, which can include receiving at least one network context (126) associated with a first communications network (114) with which a subscriber unit (102) has become affiliated, and identifying at least one communication policy (140) correlating to the network context. The method also can include communicating to the subscriber unit the identified communication policy. The invention also relates to a method (300) of enabling communication services, which can include identifying at least one network context associated with a first communications network with which a subscriber unit has become affiliated. The method further can include receiving from a server (128) at least one communication policy identified in response to the identification of the network context, the communication policy correlating to the communicated network context.

### BACKGROUND OF THE INVENTION

1. Field of the Invention

The present invention generally relates to mobile communications and, more particularly, to mobile communication services that are provided to mobile communication subscribers.

2. Background of the Invention

Providers of mobile communication services often provide value added services which are available to their subscribers. Examples of such services may include text messaging services, Internet access services, international roaming, location based services, and so on. A subscriber unit may not be configured to enable such services by default, however. For example, if a subscriber infrequently travels internationally, the subscriber may not have international roaming enabled on her subscriber unit. If the subscriber forgets to activate international roaming before departing to a foreign destination, she may not be able to use her subscriber unit to communicate when she arrives. To activate international roaming once there, the subscriber may be required to contact her communications service provider using a device other than her subscriber unit, which can be inconvenient and time consuming.

Further, certain mobile communication services may be unique to a particular service provider or a particular geographic region. For example, in a town whose economy is based on tourism, location based services may be offered that provide information about popular tourist attractions. The subscriber unit may not have prior knowledge of such services, however, and thus the subscriber may not be presented the option to use the services.

### SUMMARY OF THE INVENTION

The present invention relates to a method and a system for providing communication services. The method can include receiving at least one network context associated with a first communications network with which a subscriber unit has become affiliated, and identifying at least one communication policy correlating to the network context. The method also can include communicating to the subscriber unit the identified communication policy.

The present invention also relates to a method and a system for enabling communication services. The method can include identifying at least one network context associated with a first communications network with which a subscriber unit has become affiliated. The method further can include receiving from a server at least one communication policy identified in response to the identification of the network context, the communication policy correlating to the communicated network context.

The present invention also can be embedded in a program storage device readable by a machine, tangibly embodying a program of instructions executable by the machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 is a flowchart presenting a method of providing communication services that is useful for understanding the present invention; and

FIG. 3 is a flowchart presenting a method of enabling communication services that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

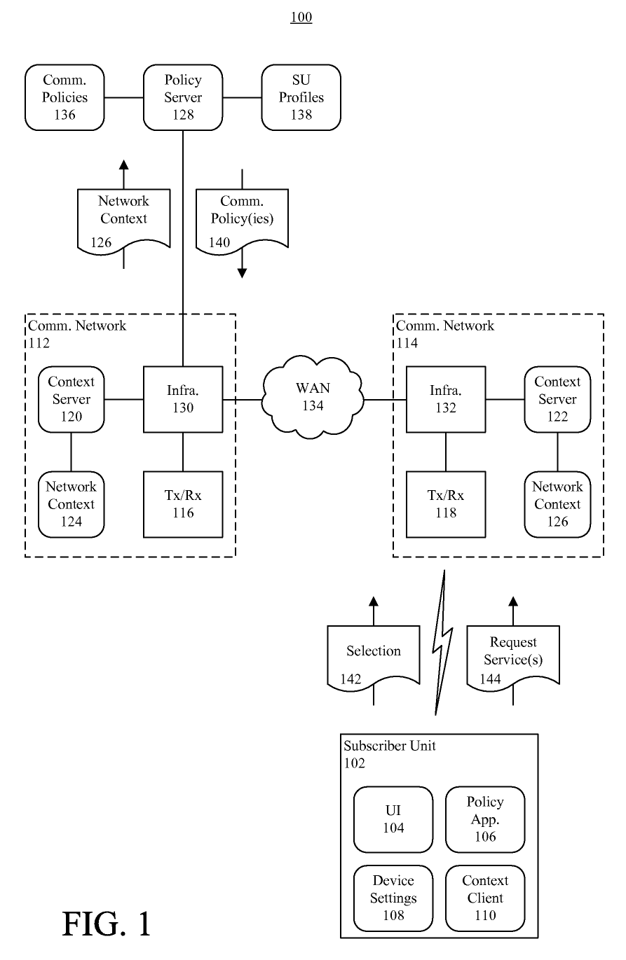

The present invention relates to a method and a system for providing communications services based on network context associated with a communications network with which a subscriber unit has become affiliated. The present invention also relates to a method and system for enabling such services. FIG. 1 depicts a communications system 100 that is useful for understanding the present invention. The communications system 100 can include at least one subscriber unit 102. The subscriber unit 102 can be, for instance, a mobile station (e.g. a mobile telephone, mobile radio, mobile computer, personal digital assistant, or the like), a computer, a wireless gaming device, user equipment, or any other device suitably configured to communicate via a wireless communications network. As such, the subscriber unit 102 can comprise one or more processors/controllers, transceivers, and/or other suitable components. The subscriber unit 102 also can include a user interface 104, which may comprise, for example, one or more displays, keys, buttons, indicator lamps, audio output transducers, audio input transducers, sensors, haptic output devices, and the like.

Further, the subscriber unit 102 can include a policy application 106, which can implement communications policies on the subscriber unit 102. Communications policies can be implemented, for instance, by selecting appropriate device settings 108 on the subscriber unit 102. Such device settings 108 can include, but are not limited to, settings that pertain to call functionality, text messaging, Internet access, global/local positioning services and navigation services. Of course, there are a myriad of other device settings that can be used to configure a subscriber unit and the invention is not limited in this regard. The policy application 106 also can present messages via the user interface 104, for example to indicate communication policies that are available to the subscriber unit, to indicate a price associated with such policies, or to present any other messages related to communications policies.

As used herein, a communication policy is data that identifies a service that may be offered to a user of a subscriber unit that is used to communicate over a communications network. Such data also can indicate whether such service is available to a particular subscriber unit and/or conditions to be met in order for the service to become available. For example, a communication policy can identify an Internet access service available to a subscriber unit and a fee for use of such service. A communication policy also may identify configuration settings that should be implemented on a subscriber unit to use the service.

The subscriber unit 102 also can include a context client 110. The context client 110 can receive network context 124, 126 from a communications network 112, 114 with which the subscriber unit 102 has become affiliated. For example, if the subscriber unit 102 has established network presence at the communications network 114, the context client 110 can receive the network context 126 from the communications network 114. As used herein, the term network context means a unique identifier that is associated with a particular communications network. Such an identifier can identify the communications network using a domain name, a uniform resource locator (URL), an internet protocol (IP) address, or any other suitable identifier. Optionally the unique identifier also can identify services provided by the particular communications network.

The communications networks 112, 114 can be dispatch communications networks, interconnect communications networks (e.g. a cellular communications network), local area networks (LANs), metropolitan area networks (MANs), and/or any other networks or systems via which communication signals can be propagated. In that regard, the communications networks 112, 114 can include wired and/or wireless communication links. Further, the communications networks 112, 114 can be operated independently of one another (e.g. operated by different service providers), or can be sub-networks of a larger communications network (e.g. operated by a common service provider).

The communications networks 112, 114 each can include at least one transceiver 116, 118, via which the subscriber unit 102 may communicate with the respective communications networks 112, 114. The transceivers 116, 118 can modulate and demodulate signals to convert signals from one form to another, and can transmit and/or receive such signals over one or more various wireless communication links. In illustration, the transceivers 116, 118 can be configured to communicate data via IEEE 802 wireless communications, for example, 802.11 and 802.16 (WiMAX). In another example, the transceivers 116, 118 can communicate data via GSM, TDMA, CDMA, WCDMA, OFDM, or direct wireless communication. In other arrangements the transceivers 116, 118 can communicate in accordance with any other suitable wireless communications protocols or techniques, and the invention is not limited in this regard.

One or more of the communications networks 112, 114 also can include, or be communicatively linked to, a respective network context server 120, 122. Each of the network context servers 120, 122 can comprise an application (e.g. software and/or firmware) that may be executed by a suitable processing system (e.g. a computer, network appliance or application specific device) to implement the methods and processes described herein which are performed by the respective network context servers 120, 122. Each of the network context servers 120, 122 may retrieve network context 124, 126 from a data storage, for example from one or more data files and/or data tables, and communicate the network context 124, 126 to the subscriber unit 102 and/or a policy server 128, as will be described herein in greater detail. The data storage can comprise one or more storage devices, each of which can include, but is not limited to, a magnetic storage medium, an electronic storage medium, an optical storage medium, a magneto-optical storage medium, and/or any other storage medium suitable for storing digital information.

The communications networks 112, 114 further can include other suitable infrastructure 130, 132. Examples of devices that may comprise the infrastructure can include, but are not limited to, routers, switches, base station systems, base station controllers, repeaters, mobile switching centers, network adapters, mobility managers, home agents, dispatch applications processors, surveillance gateways, operations maintenance configuration terminals, mobile data gateways, voice processing units, etc.

The communications networks 112, 114 can be communicatively linked with one another via a wide area network (WAN) 134. The WAN 134 can comprise the Internet, the world wide web, a public switched telephone network (PSTN), or any other suitable communications network.

The policy server 128 may be communicatively linked to infrastructure 130 of the communications network 112 and/or infrastructure 132 of the communications network 114. For example, if the communications network 112 is the home communications network for the subscriber unit 102, then the policy server 128 can be communicatively linked to the infrastructure 130. In one arrangement, the policy server 128 may be instantiated on a processing system that is a component of the infrastructure 130. Further, a second policy server (now shown) can be communicatively linked to the infrastructure 132 of the communications network 114. In such an arrangement, the second policy server can communicate with the policy server 128 in accordance with one or more roaming agreements between their respective service providers.

The policy server 128 also may be communicatively linked to a data storage from which the policy server 128 may retrieve communication policies 136, retrieve subscriber unit profiles 138 and/or update the subscriber unit profiles 138. The communication policies 136 and subscriber unit profiles 138 can be contained in one or more data files and/or data tables, for instance within a database. As noted, the data storage can comprise one or more storage devices, each of which can include, but is not limited to, a magnetic storage medium, an electronic storage medium, an optical storage medium, a magneto-optical storage medium, and/or any other storage medium suitable for storing digital information.

In operation, the subscriber unit 102 can become affiliated with (e.g. establish network presence at) the communications network 114 while roaming outside of its home communications network 112. Responsive to such affiliation, the context server 122 can communicate to the subscriber unit 102 (e.g. to the context client 110) network context 126 associated with the communication network 114. The subscriber unit 102 then can forward the network context 126 to the policy server 128 via the communications network 114. The policy server 128 can be communicatively linked to the subscriber unit's home communications network.

In another arrangement, the subscriber unit 102 can identify the policy server 128 to the communications network 114, for example in a message communicated to the communications network 114 during or after network affiliation. The communications network 114 can route such message to the context server 122, or the communications network 114 can parse an identifier associated with the policy server 128 from the message and communicate the identifier to the context server 122. Such routing and/or parsing can be performed by the network infrastructure 132. The context server 122 then can communicate the network context 126 to the policy server 128.

The policy server 128 can receive the network context 126 and, from among the communication policies 136, identify one or more communication policies 140 that correlate to the network context 126. For example, if the network context 126 identifies the communications network 114, the policy server 128 can identify one or more communication policies 140 associated with the communications network 114. If the network context 126 identifies specific services and/or features (herein collectively referred to as “services”) provided by the communications network 114, the policy server 128 can identify communication policies 140 that correspond to such services. In one arrangement, each of the selected communication policies 140 can be policies that are exclusively associated with the communications network 114.

In one aspect of the inventive arrangements, the communication policies 136 can be based on roaming agreements between various communication service providers, such as those who manage the communications networks 112, 114. For example, a communication policy 136 can indicate that subscriber units whose home communications network is the communications network 112 are provided free or discounted communication rates when communicating via the communications network 114.

The policy server 128 can update the subscriber unit profile 138 that corresponds to the subscriber unit 102. For example, the policy server 128 can update the subscriber unit profile 138 with the network context 126 and/or the identified communication policies 140, or identifiers that correspond to the network context 126 and/or communication policies 140. In this manner the policy server 128 can maintain knowledge of services currently available to the subscriber unit 102.

The policy server 128 also can send the communication policies 140 to the subscriber unit 102, for instance via the WAN 134 and the communications network 114. The policy application 106 can respond with a message to the policy server 128 indicating the communications policies 140 were received and verifying the content of the communications policies 140. Such verification can be implemented in any suitable manner, for example by performing a redundancy check such as checksum.

The policy application 106 also can process the communication policies 140 and perform suitable tasks. For example, if the communication policies 140 indicate that Internet access is available to the subscriber unit 102 via the communications network 114 for a fee, the policy application can present such information via the user interface 104. For instance, the policy application 106 can display text indicating such service is available and prompt a user to make a particular selection if the user wishes to enable the service.

In response to a user selecting a service that is offered, the policy application 106 can communicate a message 142 to the policy server 128 indicating such selection. The policy server 128 then can update the subscriber unit profile 138 associated with the subscriber 102 to indicate the services that have been selected. Such information can be useful for billing purposes.

If additional software/firmware is required to enable a service on the subscriber unit 102, the message 142 also can request download of such software/firmware from the policy server 128. If the software/firmware is not available from the policy server 128, a message (not shown) can be communicated from the subscriber unit 102 or the policy server 128 to a network node from which the software/firmware may be downloaded. In an arrangement in which the subscriber unit 102 sends the message requesting the download, the policy server 128 can identify to the subscriber unit 102 the network node where the message is to be sent. The network node can be identified in the communication policies 140 communicated to the subscriber unit 102 or in another suitable message.

The policy application 106 can automatically update any device settings 108 for the subscriber unit 102 that may be necessary to enable a service. For example, the policy application 106 can instantiate a particular client application that may be needed, implement a particular communications protocol, etc. As noted, the required subscriber unit configuration can be identified by the communications policies 140.

The policy application 106 also can communicate a message 144 to the communications network 114 to request that the selected services on the communications network 114 be enabled for the subscriber unit 102. Alternatively, such message 144 can be communicated from the policy server 128 in response to receiving the message 142.

At this point it should be noted that the policy application 106, context client 110, context servers 120, 122 and policy server 128 each can be realized in hardware, software, or a combination of hardware and software. Such components can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The policy application 106, context client 110, context servers 120, 122 and policy server 128 each can be embedded in one or more program storage devices readable by a machine, tangibly embodying a program of instructions executable by the machine to perform methods and processes described herein. The components also can be embedded in one or more application products which comprises all the features enabling the implementation of the methods described herein and, which when loaded in a processing system, are able to carry out these methods.

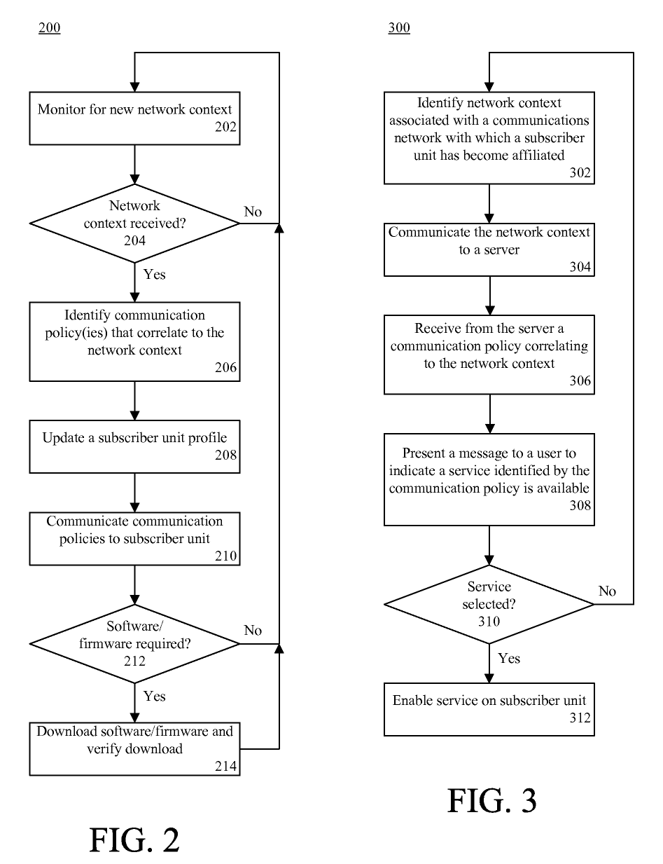

FIG. 2 is a flowchart presenting a method 200 for providing communication services that is useful for understanding the present invention. At step 202, the policy server can monitor for network context. Referring to decision box 204, if network context is received, the process can proceed to step 206. As noted, the network context can be received from a subscriber unit or a communications network with which the subscriber unit has become affiliated while roaming outside of its home communications network. The network context can include an identifier that identifies the first communications network, for instance with a domain name, a URL or an IP address. Optionally the network context also can include an identifier that identifies one or more services available via the communications network.

At step 206 the policy server can identify one or more communication policies that correlate to the received network context. At step 208 the policy server can update a subscriber unit profile that corresponds to the subscriber unit to indicate that one or more services associated with the communication policy are available to the subscriber unit. For example, the subscriber unit profile can be updated with the received network context and/or the identified communication policies. Proceeding to step 210, the policy server can communicate the communication policies to the subscriber unit.

Continuing to decision box 212, if the subscriber unit requires software or firmware to use services indicated by the communication policies, at step 214 such software/firmware can be communicated to the subscriber unit. As noted, the download can be requested by the subscriber unit or the policy server. Further, the software/firmware can be provided by the policy server or another suitable network node.

FIG. 3 is a flowchart presenting a method 300 of enabling communication services that is useful for understanding the present invention. At step 302, network context associated with a communications network can be identified. The communications network can be one with which a subscriber unit has become affiliated, for example while roaming outside its home communications network. Identification of the network context can be performed by the subscriber unit or another system, for instance infrastructure of the subscriber unit's home communications network. At step 304, the network context can be communicated to a server, for instance a policy server.

At step 306, at least one communication policy that corresponds to the network context can be received from the server. In one arrangement, the communications policy can be received on the subscriber unit. In another arrangement, the communications policy can be received by the infrastructure of the subscriber unit's home communications network.

At step 308 a message can be presented to a user to indicate a service identified by the communication policy is available to the subscriber station. Such message also can prompt the user to select whether to enable such service. In one arrangement the message can be generated by the subscriber station and presented via a user interface. In another arrangement, the message can be generated by the infrastructure of the subscriber unit's home communications network and communicated to the subscriber station, which then can present the message via the user interface.

Referring to decision box 310, if the user selects to enable the service, at step 312 the service can be enabled on the subscriber unit, for example by processing the communication policy. As noted, software and/or firmware which may be required to enable the service also can be downloaded to the subscriber unit.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terms “computer program,” “software,” “application,” variants and/or combinations thereof, in the present network context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A method of providing communication services, comprising:
receiving at least one network context associated with a first communications network with which a subscriber unit has become affiliated;
identifying at least one communication policy correlating to the network context; and
communicating to the subscriber unit the identified communication policy.

2. The method of claim 1, wherein receiving the network context associated with the first communications network comprises receiving network context associated with a communications network with which the subscriber unit has become affiliated while the subscriber unit is roaming outside of its home communications network.

3. The method of claim 1, further comprising:
based on the received network context, updating a profile associated with the subscriber unit to indicate that at least one service associated with the communication policy is available to the subscriber unit.

4. The method of claim 1, wherein receiving the network context comprises receiving at least one identifier associated with the first communications network, the identifier selected from the group consisting of a domain name, a uniform resource locator (URL) and an internet protocol (IP) address.

5. The method of claim 1, wherein receiving the network context comprises receiving at least one identifier that identifies a service available via the first communications network.

6. The method of claim 1, wherein communicating to the subscriber unit the communication policy comprises communicating the communication policy such that, on the subscriber unit, at least one service available from the first communications network is enabled.

7. The method of claim 1, wherein receiving the network context comprises receiving the network context from the subscriber unit.

8. The method of claim 1, wherein receiving the network context comprises receiving the network context from the first communications network.

9. The method of claim 1, wherein identifying the communication policy comprises identifying a communication policy that is exclusively associated with the first communications network.

10. A method of enabling communication services, comprising:
identifying at least one network context associated with a first communications network with which a subscriber unit has become affiliated; and
receiving from a server at least one communication policy identified in response to the identification of the network context, the communication policy correlating to the communicated network context.

11. The method of claim 10, wherein identifying the network context associated with the first communications network comprises identifying network context associated with a communications network with which the subscriber unit has become affiliated while the subscriber unit is roaming outside of its home communications network.

12. The method of claim 10, further comprising communicating the network context to the server.

13. The method of claim 10, further comprising presenting on the subscriber unit a message that indicates a service identified by the communication policy is available.

14. The method of claim 13, further comprising prompting the user to select whether to enable at least one service associated with the first communications network.

15. A program storage device readable by a machine, tangibly embodying a program of instructions executable by the machine to perform method steps for providing communication services, said method steps comprising:
receiving at least one network context associated with a first communications network with which a subscriber unit has become affiliated;
identifying at least one communication policy correlating to the network context; and
communicating to the subscriber unit the identified communication policy.

16. The program storage device of claim 15, wherein receiving the network context associated with the first communications network comprises receiving network context associated with a communications network with which the subscriber unit has become affiliated while the subscriber unit is roaming outside of its home communications network.

17. The program storage device of claim 15, wherein communicating to the subscriber unit the communication policy comprises communicating the communication policy such that, on the subscriber unit, at least one service available from the first communications network is enabled.

18. A program storage device readable by a machine, tangibly embodying a program of instructions executable by the machine to perform method steps for enabling communication services, said method steps comprising:
identifying at least one network context associated with a first communications network with which a subscriber unit has become affiliated; and
receiving from a server at least one communication policy identified in response to the identification of the network context, the communication policy correlating to the communicated network context.

19. The program storage device of claim 18, wherein identifying the network context associated with the first communications network comprises identifying network context associated with a communications network with which the subscriber unit has become affiliated while the subscriber unit is roaming outside of its home communications network.

20. The program storage device of claim 18, said method steps further comprising communicating the network context to the server.
